(19) United States
(12) Patent Application Publication
(10) Pub. No.: US 2006/0056804 A1
(43) Pub. Date: Mar. 16, 2006

(54) Recording medium, and method and apparatus for reproducing data from the recording medium

(76) Inventors: Kang Soo Seo, Anyang-si (KR); Jea Yong Yoo, Seoul (KR); Byung Jin Kim, Seongnam-si (KR)

Correspondence Address: HARNESS, DICKEY & PIERCE, P.L.C., P.O. BOX 8910, RESTON, VA, 20195, US

(21) Appl. No.: 11/224,244

(22) Filed: Sep. 13, 2005

Related U.S. Application Data
(60) Provisional application No. 60/608,895, filed on Sep. 13, 2004.

(30) Foreign Application Priority Data
Oct. 21, 2004 (KR) 10-2004-0084509
Oct. 21, 2004 (KR) 10-2004-0084510

(51) Int. Cl. H04N 5/783

(52) U.S. Cl. 386/69; 386/125

(57) ABSTRACT

A recording medium, and a method and apparatus for reproducing data from the recording medium are disclosed. The recording medium includes an area in which a first title and a second title having different attributes are recorded; and a management area for reproducing individual titles having different attributes, wherein the management area records a first index file for a first player capable of reproducing only a specific title, and a second index file for a second player capable of reproducing all titles. Therefore, although a player is designed to reproduce only the specific title, it can perform stable operations.

This application claims the benefit of U.S. Provisional Application No. 60/608,899, filed on Sep. 13, 2004, in the name of inventors Kang Soo SEO, Jea Yong YOO, and Byung Jin KIM, entitled “METHOD OF ENHANCED SEARCHING THE CONTENTS IN BLU-RAY DISC”, which is hereby incorporated by reference as if fully set forth herein.

This application claims the benefit of Korean Patent Application No. 10-2004-0084509, filed on Oct. 21, 2004, and No. 10-2004-0084510, also filed on Oct. 21, 2004, which are hereby incorporated by reference as if fully set forth herein.

### BACKGROUND OF THE INVENTION

1. Field of the Invention

The present invention relates to a recording medium, and more particularly to a recording medium file structure for effectively reproducing data having different attributes recorded in the recording medium, and a method and apparatus for reproducing the data using the recording medium file structure.

2. Discussion of the Related Art

Generally, there has been widely used an optical disc acting as a recording medium capable of recording a large amount of data therein. Particularly, there has recently been developed a high-density optical recording medium capable of recording/storing high-quality video data and high-quality audio data for a long period of time, for example, a Blu-ray Disc (BD).

The BD based on the next-generation recording medium technique has been considered to be the next-generation optical recording solution capable of storing much more data than a conventional DVD. In recent times, many developers have conducted intensive research into the international standard technical specification associated with the BD along with those of other digital devices.

Particularly, the above-mentioned BD can record a plurality of data units having different attributes, for example, a first title wherein a movie compressed in an MPEG2 format is recorded, a second title wherein interactive information including movies executed by a Java program is recorded, a third title recorded by a Web-language.

However, a method and apparatus for reproducing the above-mentioned data (e.g., titles) having different attributes are not yet well known to those skilled in the art associated with the BD specification, such that many limitations and problems occur in developing a BD-based optical recording/reproducing device.

### SUMMARY OF THE INVENTION

Accordingly, the present invention is directed to a recording medium, and a method and apparatus for reproducing data from the recording medium that substantially obviate one or more problems due to limitations and disadvantages of the related art.

An object of the present invention is to provide a method and apparatus for reproducing data from a recording medium in which data having different attributes is recorded.

Another object of the present invention is to provide a file structure for reproducing/managing data having different attributes in a recording medium storing various attribute data, and a method for constructing menu information and a presentation scenario in the file structure so that a desired operation can be performed even in an apparatus capable of reproducing only a specific title.

A further object of the present invention is to provide a method and apparatus for reproducing data from a recording medium using a file structure contained in the recording medium.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a recording medium includes an area in which a first title and a second title having different attributes are recorded; and a management area for reproducing individual titles having different attributes, wherein the management area records a first index file for a first player capable of reproducing only a specific title, and a second index file for a second player capable of reproducing all titles.

In another aspect of the present invention, a recording medium includes an area in which a first title and a second title having different attributes are recorded; and an area in which at least one menu information for constructing different menu images according to reproduction or non-reproduction information of the first and second titles is recorded.

In another aspect of the present invention, a recording medium includes an area in which a first title and a second title having different attributes are recorded; and a management area for reproducing individual titles having different attributes, wherein the management area records a presentation scenario for use in a player capable of reproducing only a specific title.

Preferably, the first title is an HDMV title, and the second title is a Java title. The management area further records a presentation scenario for use in a player capable of reproducing only the HDMV title.

In another aspect of the present invention, a method for reproducing data of a recording medium in which a first title and a second title having different attributes are recorded and a plurality of index files for reproducing individual titles having different attributes are recorded, includes the steps of (a) selecting one of the index files recorded in the recording medium according to player type information; and (b) reproducing data of the recording medium using presentation scenario information recorded in the selected index file.

In another aspect of the present invention, a method for reproducing data of a recording medium in which a first title and a second title having different attributes are recorded and menu information for reproducing the first and second titles having different attributes according to player type (player_type) information is recorded, includes the steps of (a) selecting one of first menu information of the first title recorded in the recording medium and second menu information including the second title recorded in the recording medium according to the player type (player_type) information; (b) displaying a menu image using the selected menu information; and (c) reproducing a specific title contained in the displayed menu image according to a reproduction command of a user. The method may further include a step (d) displaying a Java title when a menu image is displayed by HDMV title menu information, and preventing the Java title from being selected by the user.

In another aspect of the present invention, a method for reproducing data of a recording medium in which a first title and a second title having different attributes are recorded and a presentation scenario changed according to player type information is recorded, includes the steps of (a) if the recording medium is loaded, reading a scenario capable of being reproduced from the recording medium; and (b) reproducing data of the recording medium according to the read scenario.

In another aspect of the present invention, an apparatus for reproducing data of a recording medium in which a first title and a second title having different attributes are recorded and different presentation scenarios according to player type information are recorded, includes a recording/reproducing unit for reading a presentation scenario capable of being reproduced, from among the presentation scenarios recorded in the recording medium; and a player model for reproducing a specific title on the basis of the read presentation scenario.

In a further aspect of the present invention, an apparatus for reproducing data of a recording medium in which a first title and a second title having different attributes are recorded and menu information for reproducing the first and second titles having different attributes according to player type (player_type) information is recorded, includes a recording/reproducing unit for reading one of first menu information of the first title recorded in the recording medium and second menu information including the second title recorded in the recording medium according to the player type (player_type) information; and a player model for displaying a menu image using the read menu information, and reproducing a specific title contained in the menu image according to a reproduction command of a user.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a conceptual diagram illustrating individual titles recorded in a recording medium according to the present invention;

FIG. 2 is a diagram illustrating a file structure recorded in an optical disc acting as a recording medium and a relationship for reproducing data of the file structure according to the present invention;

FIG. 3 is a structural diagram illustrating a data record structure recorded in an optical disc according to the present invention;

FIGS. 4a˜4b are structural diagrams illustrating individual file structures according to the present invention;

FIG. 4c is a diagram illustrating a reproduction relationship using the file structures shown in FIGS. 4a˜4b according to the present invention;

FIG. 5a is a diagram illustrating a relationship for displaying a menu image using menu information according to the present invention;

FIGS. 5b□5d are diagrams illustrating a method for recording a plurality of menu information units in a disc in accordance with a preferred embodiment of the present invention;

FIGS. 6a˜6b are diagrams illustrating a transition relationship between titles having different attributes according to the present invention;

FIG. 7 is a diagram illustrating a method for constructing a movie object (M-OBJ) command for use in an optical recording/reproducing device capable of reproducing only an HDMV title in accordance with a preferred embodiment of the present invention;

FIG. 8a is a file structure for recording a plurality of index files therein according to the present invention;

FIG. 8b˜8c are diagrams illustrating a method for constructing a menu image using a plurality of index files according to the file structure shown in FIG. 8a in accordance with a preferred embodiment of the present invention;

FIGS. 8d˜8e are diagrams illustrating a method for changing a presentation scenario for use in an optical recording/reproducing device capable of reproducing only the HDMV title according to the file structure shown in FIG. 8a in accordance with a preferred embodiment of the present invention;

FIGS. 9a˜9b are diagrams illustrating a method for establishing a presentation scenario for use in an optical recording/reproducing device capable of reproducing only the HDMV title according to the file structure shown in FIG. 8a in accordance with a preferred embodiment of the present invention;

FIG. 10a is a block diagram illustrating an optical recording/reproducing device according to the present invention; and

FIG. 10b is a block diagram illustrating a player model according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

A method and apparatus for reproducing data from a recording medium will hereinafter be described with reference to the annexed drawings.

Prior to describing the present invention, it should be noted that most terms disclosed in the present invention correspond to general terms well known in the art, but some terms have been selected by the applicant as necessary and will hereinafter be disclosed in the following description of the present invention. Therefore, it is preferable that the terms defined by the applicant be understood on the basis of their meanings in the present invention.

A recording medium for use in the present invention is indicative of all storage mediums, for example, an optical disc, and a magnetic tape, etc., according to various recording schemes. For the convenience of description and better understanding of the present invention, the optical disc, such as a BD, will hereinafter be exemplarily used as the above-mentioned recording medium in the present invention. It should be noted that technical ideas of the present invention can be applied to other recording mediums without departing from the scope and spirit of the invention.

The term “Title” is indicative of a reproduction unit interfacing with a user, and each title is linked to a specific object, such that a stream associated with a corresponding title recorded in a disc is reproduced according to a command or program stored in the object.

A title recorded in a disc and a disc file structure for reproducing the title will be described with reference to FIG. 2. Particularly, for the convenience of description and better understanding of the present invention, a first title in which movies and interactive information according to an MPEG2 compression scheme are recorded is called an HDMV title, and a second title in which movies and interactive information according to a Java program are recorded is called a Java title.

The term “Object” is indicative of reproduction management information including a command or program for reproducing the disc. In other words, a variety of objects present in a disc are linked to a specific title or are connected to other objects. Therefore, the above-mentioned objects are pre-designed according to intentions of a manufacturer or author of the disc, are recorded in the disc, and increase the number of scenarios for reproducing data of the disc. In other words, the term “Object” is indicative of a reproduction management unit including a command or program for managing a presentation scenario of data recorded in the disc.

For the convenience of description and better understanding of the present invention, the above-mentioned term “HDMV Title” will hereinafter be referred to as “M-OBJ”, and the above-mentioned term “Java Title” will hereinafter be referred to as “Java Object” or “J-OBJ”.

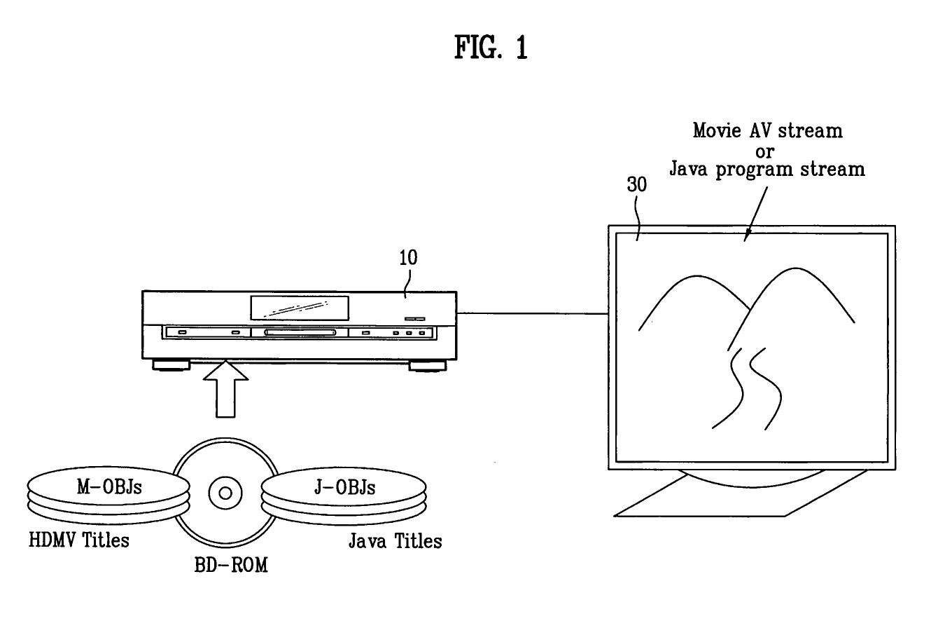

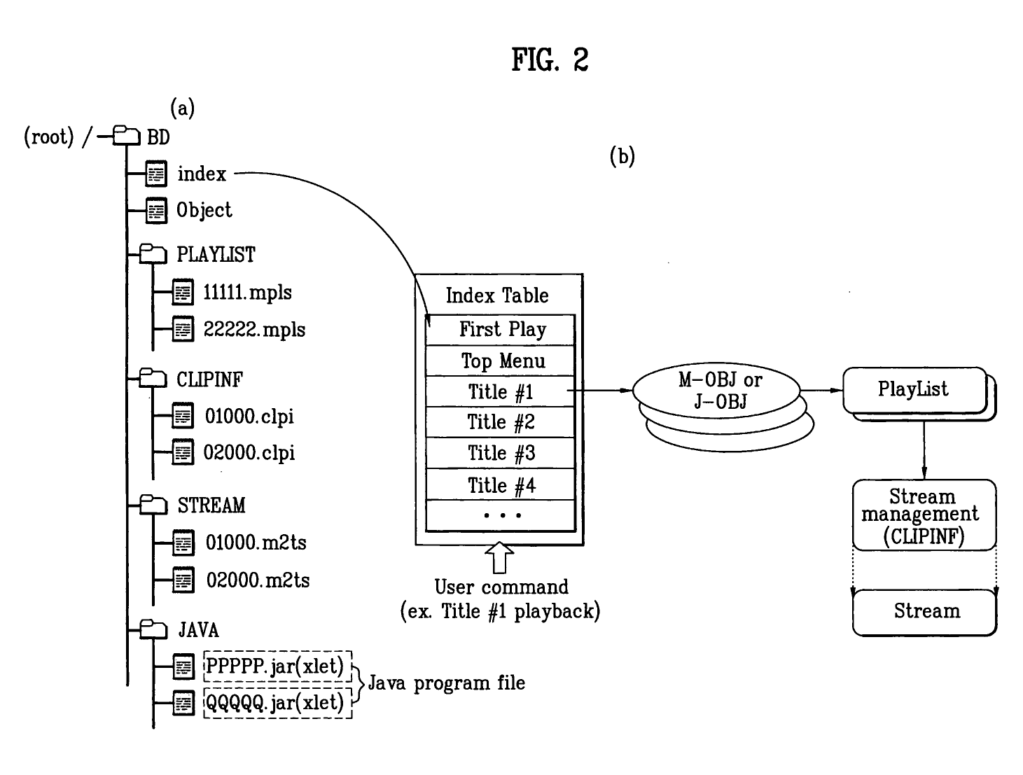

FIG. 1 is a conceptual diagram illustrating individual titles recorded in a recording medium according to the present invention. In more detail, FIG. 1 shows an example of a BD-ROM for use in an optical recording/reproducing device 10.

FIG. 1 shows a specific mode in which a title recorded in the BD-ROM is mixed with an HDMV title and a Java title, such that the title mixed with the HDMV and JAVA titles is recorded. The specific mode is called a full mode. The present invention provides a file structure standardized in the disc in order to record/reproduce data in/from the BD-ROM based on the full mode, and provides a method and apparatus for reproducing data from the BD-ROM.

The optical recording/reproducing device 10 can record/reproduce data in/from various optical discs having different formats. If necessary, the optical recording/reproducing device 10 can record/reproduce specific data in/from only a specific optical disc such as a BD, or can reproduce the data from the optical disc without recording the data in the same. It should be noted that the present invention uses a BD-player capable of reproducing data from the BD-ROM based on a BD format as a preferred embodiment for the convenience of description. It is well known in the art that the optical recording/reproducing device 10 is also applicable to a drive embedded in a specific device such as a computer.

The optical recording/reproducing device 10 reproduces data from the BD-ROM, reads data from the BD-ROM, performs a signal process and a decoding process on the read data according to attribute information of the read data, and transmits the signal processed result and the decoding result to a display 30 connected to the optical recording/reproducing device 10, such that a user can view the signal processed result and the decoding result on the display 30.

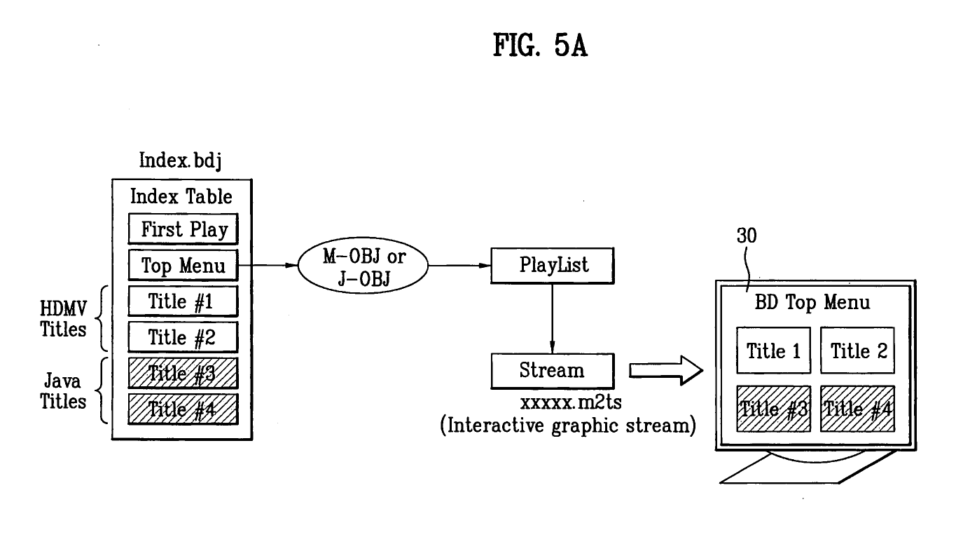

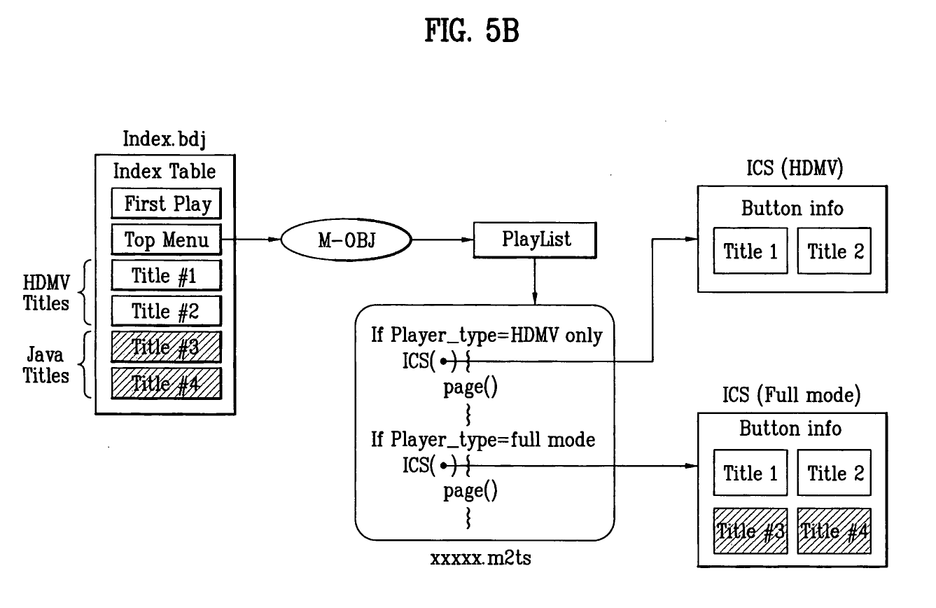

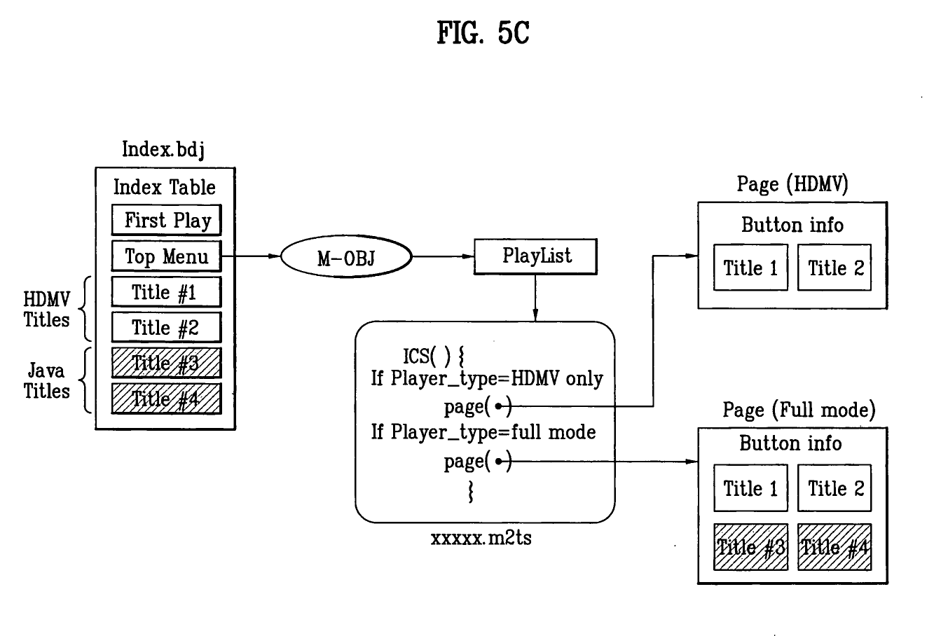

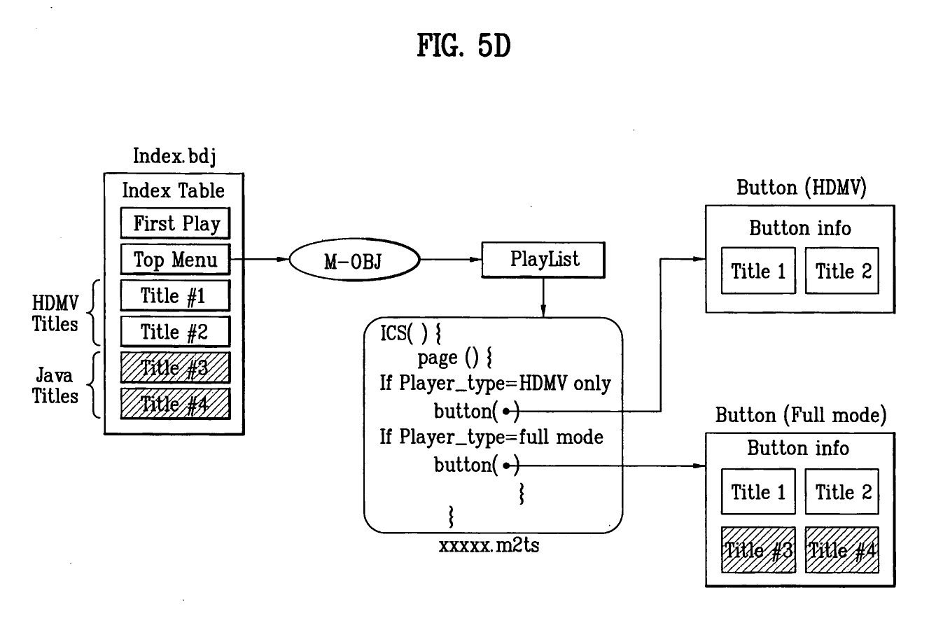

In association with the above-mentioned description, although the optical recording/reproducing device 10 according to the present invention is generally designed to reproduce all titles having different attributes stored in the BD-ROM disc, it should be noted that a certain optical recording/reproducing device may reproduce only a title having a specific attribute (e.g., an HDMV title). Specifically, the present invention includes a unique file structure in the BD-ROM disc to maintain a presentation scenario even in the optical recording/reproducing device 10 capable of reproducing only the above-mentioned title (e.g., an HDMV title), and a detailed description thereof will be described later with reference to FIGS. 5˜10.

FIG. 2 is a diagram illustrating a file structure (a) recorded in an optical disc such as BD-ROM and a relationship (b) among files stored in the file structure (a) when reproducing a specific title from the file structure (a) according to the present invention.

The above-mentioned file structure (a) shown in FIG. 2 will hereinafter be described.

The reproduction/management file structure (a) includes one or more BD directories in a single root directory. The BD directory includes not only an index file “index” acting as a general file (i.e., an upper file) capable of guaranteeing user interactivity, but also the above-mentioned object. The reproduction/management file structure (a) includes a variety of directories for storing information of actual data recorded in a disc and other information associated with a method for reproducing the data, for example, a playlist directory (PLAYLIST), a clip information directory (CLIPINF), a stream directory (STREAM), and a java directory (JAVA). The above-mentioned directories and a variety of files included in the directory will hereinafter be described.

The stream directory (STREAM) includes a plurality of AV (Audio and Video) stream files recorded in a disc according to a specific format. For example, the stream directory (STREAM) uses extension names of stream files (01000.m2ts and 02000.m2ts) as a specific extension name “*.m2ts”. Generally, the stream file contains moving image data.

The clip information (Clip-info) directory (CLIPINF) is composed of a plurality of clip-info files (01000.clpi and 02000.clpi) connected to the above-mentioned stream files on a one-to-one basis. Particularly, the clip-info files (*.clpi) contain attribute information and timing information of the stream files therein. The clip-info files (*.clpi) connected to the stream files (*.m2ts) on a one-to-one basis are generically named a “Clip” in a BD standard. In other words, this means that a single stream file (*.m2ts) must correspond to a clip-info file (*.clpi).

The playlist directory (PLAYLIST) includes a plurality of playlist files (*.mpls). Each playlist file (*.mpls) includes one or more playitems (PlayItem) for designating a playing interval during which a specific clip is reproduced. The playitem (PlayItem) includes information associated with a specific clip to be reproduced, i.e., information associated with a reproduction start time (IN-Time) and other information associated with a reproduction termination time (OUT-Time) of a clip determined to be a clip name (Clip_Information_File_name) contained in the playitem (PlayItem).

The playlist file (*.mpls) is used as a basic reproduction/management file unit contained in an overall reproduction/management file structure, such that it can reproduce a desired clip using a combination of one or more playitems. The playlist file (*.mpls) may include data different from reproduction data formed by the playitem. Particularly, the playlist file (*.mpls) may include a sub-playitem (SubPlayItem) for reproducing auxiliary data.

The playlist file (*.mpls) is operated by a command or program of the above-mentioned object. From the viewpoint of a disc presentation scenario, the object executes or manages a dynamic scenario, and the playlist file (*.mpls) executes or manages a static scenario.

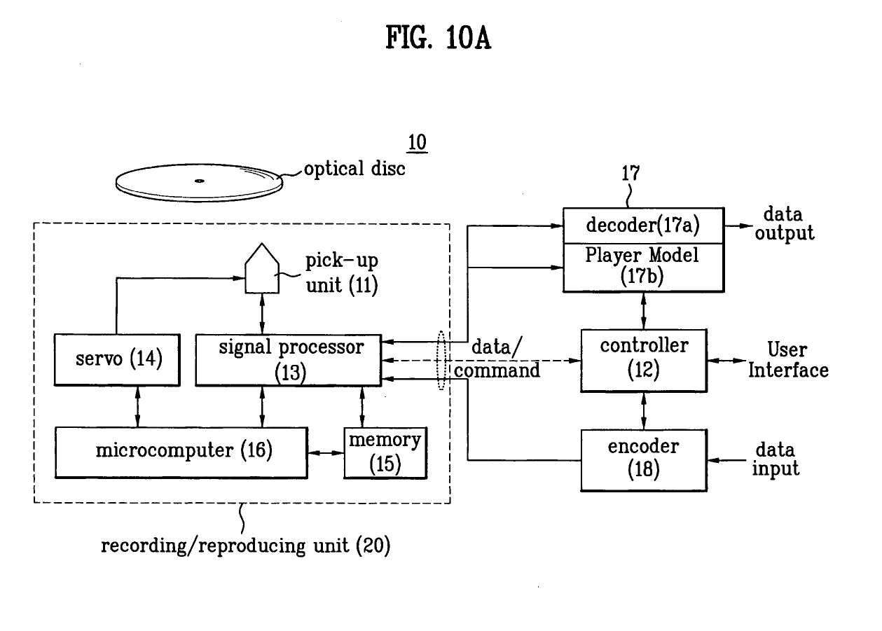

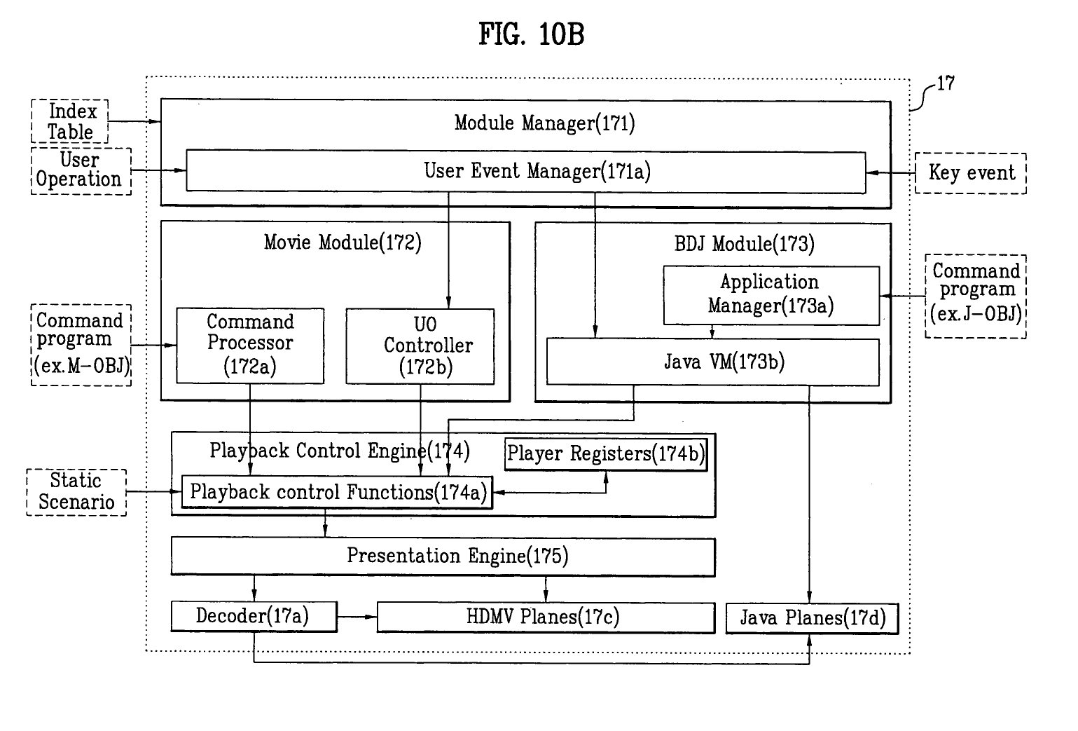

The Java directory (JAVA) records a plurality of Java program files (e.g., PPPPP.jar or QQQQQ.jar) therein. A variety of applications are programmed in individual Java program files, and each of the programmed applications may also be called an “Xlet”. The Java program files are executed by a dedicated reproduction device, and a detailed description thereof will be described later with reference to FIG. 10b.

The reference character (b) shown in FIG. 2 shows a relationship for reproducing a specific title using the above-mentioned file structure (a) of FIG. 2. Specifically, upon receiving a title reproduction command from a user in association with a specific title applied to an index table of an index file, the relationship for reproducing the specific title is described in FIG. 2(b).

If data of a corresponding disc is loaded, the index file includes first play information “First Play” indicative of information associated with a first reproduction image, top menu information “TopMenu” capable of providing a title recorded in a disc with a menu image, and at least one title information (e.g., Title #1˜Title #4). In more detail, the above-mentioned titles Title #1˜Title #4 may be configured in the form of an HDMV title or a Java title.

Thereafter, if the user selects a command for reproducing a specific title (e.g., Title #1), a specific playlist is reproduced according to a specific object command or program linked to the title (Title#1) in the object file of the file structure (a), and a specific clip “*clip” or “*.m2ts” is reproduced by a playitem contained in the playlist.

If the selected title (Title #1) is determined to be the HDMV title, it is reproduced by a specific object “M-OBJ” contained in a single object file. Otherwise, if the selected title (Title #1) is determined to be the Java title, it is reproduced by a specific object “J-OBJ”.

Particularly, the present invention provides a variety of preferred embodiments associated with a method for constructing menu information and a method for constructing a presentation scenario for the optical recording/reproducing device 10 capable of reproducing only a specific title (e.g., an HDMV title), and a detailed description thereof will hereinafter be given with reference to FIGS. 5□9b.

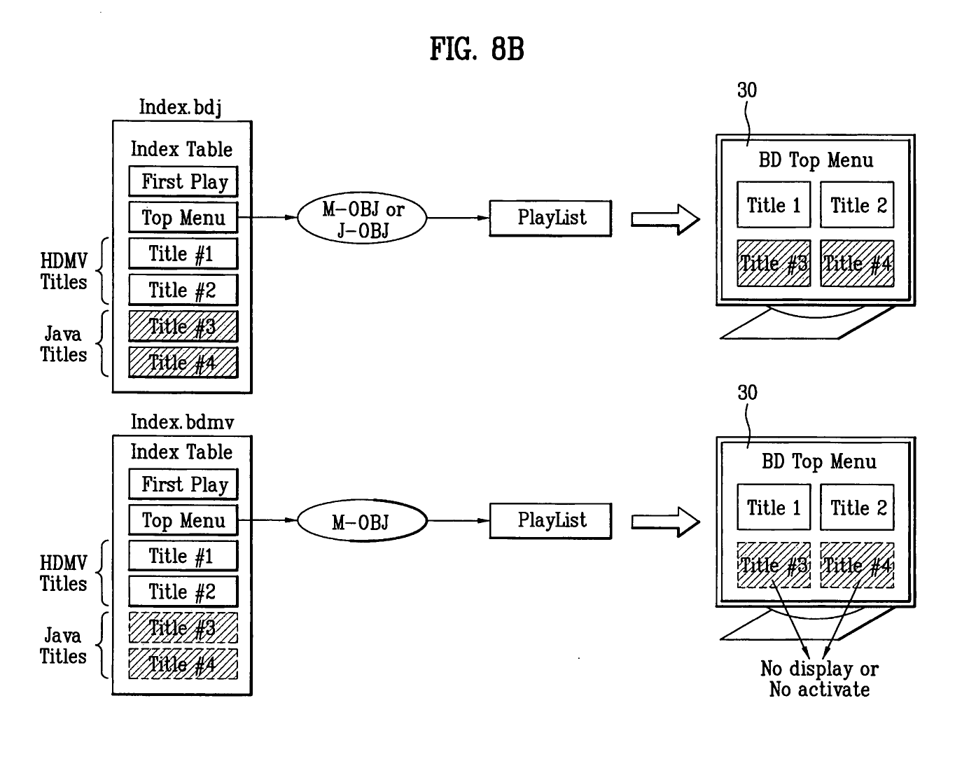

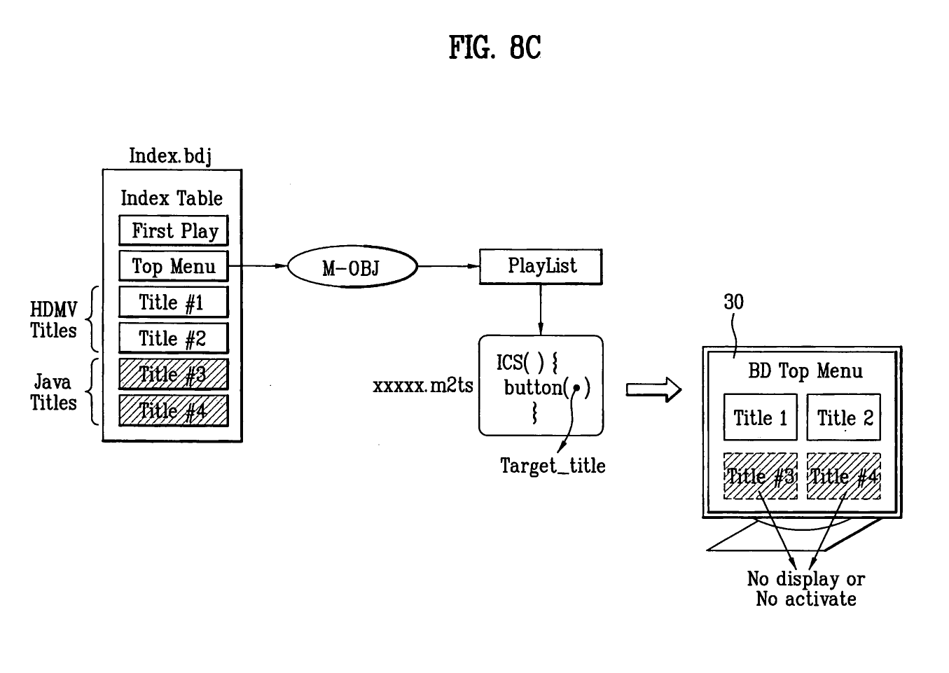

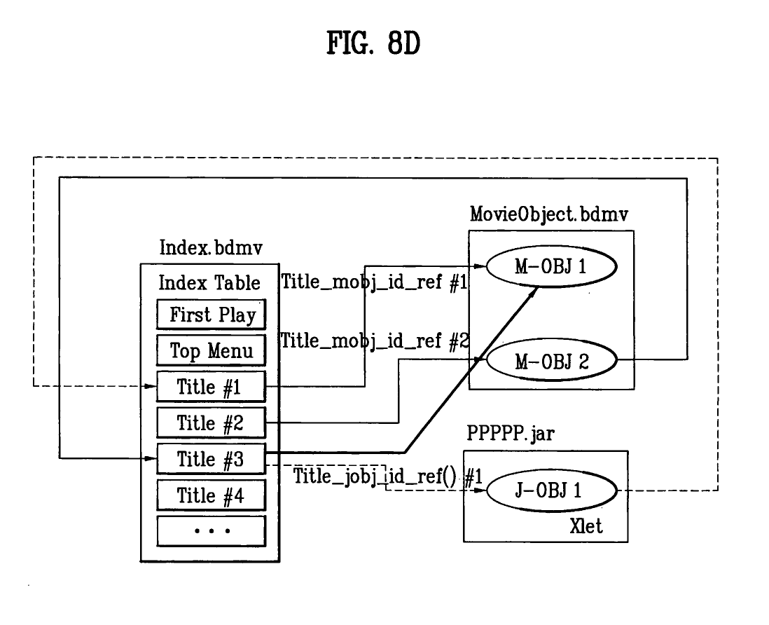

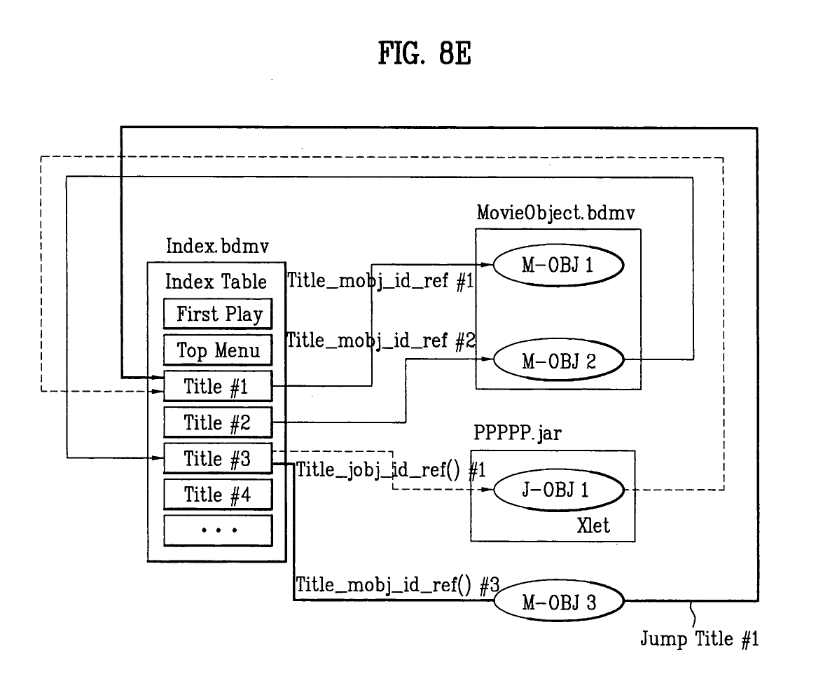

In association with the above-mentioned description, the above-mentioned index file is configured in the form of “index.bdj”, such that both the HDMV title and the Java title can be indexed. Otherwise, the above-mentioned index file may include a specific file for indexing only the HDMV title for the optical recording/reproducing device 10 capable of reproducing only the HDMV title, such that it may also be configured in the form of two index files. A detailed description thereof will be described later with reference to FIGS. 8□12.

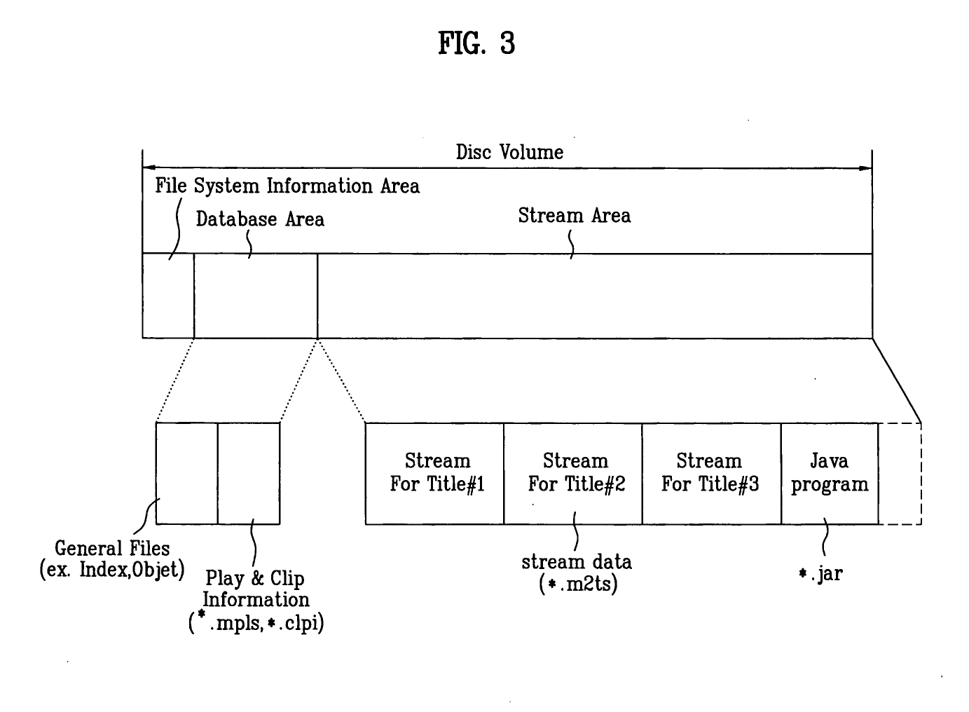

FIG. 3 is a structural diagram illustrating an exemplary disc structure for recording information associated with the file structure (a) in a disc. As shown in FIG. 3, from the viewpoint of an inner area of the disc, the above-mentioned disc structure sequentially includes a file system information area serving as system information for managing overall files, a database area for recording a playlist file and a clip-info file to reproduce a recorded stream (*.m2ts), and a stream area for recording a plurality of streams composed of audio data, video data, and graphic data, etc. Particularly, it should be noted that data recorded in the stream area of the disc may be determined to be data having different attributes as previously stated above.

A predetermined area for recording the HDMV title and the Java title is referred to as a title record area, and corresponds to the above-mentioned stream area shown in FIG. 3. A predetermined area for recording file information for title reproduction is referred to as a management area, and corresponds to the file system information area and the database area. It should be noted that individual areas shown in FIG. 3 have been provided to describe an example, and the present invention is not limited to an arrangement structure of the above-mentioned areas shown in FIG. 3, and is applicable to other examples as necessary.

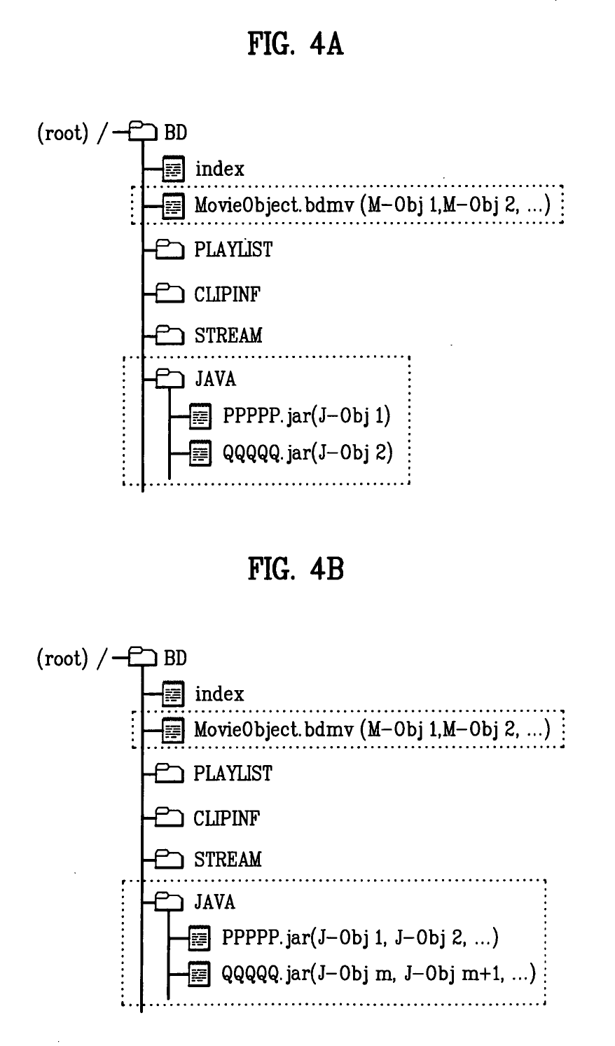

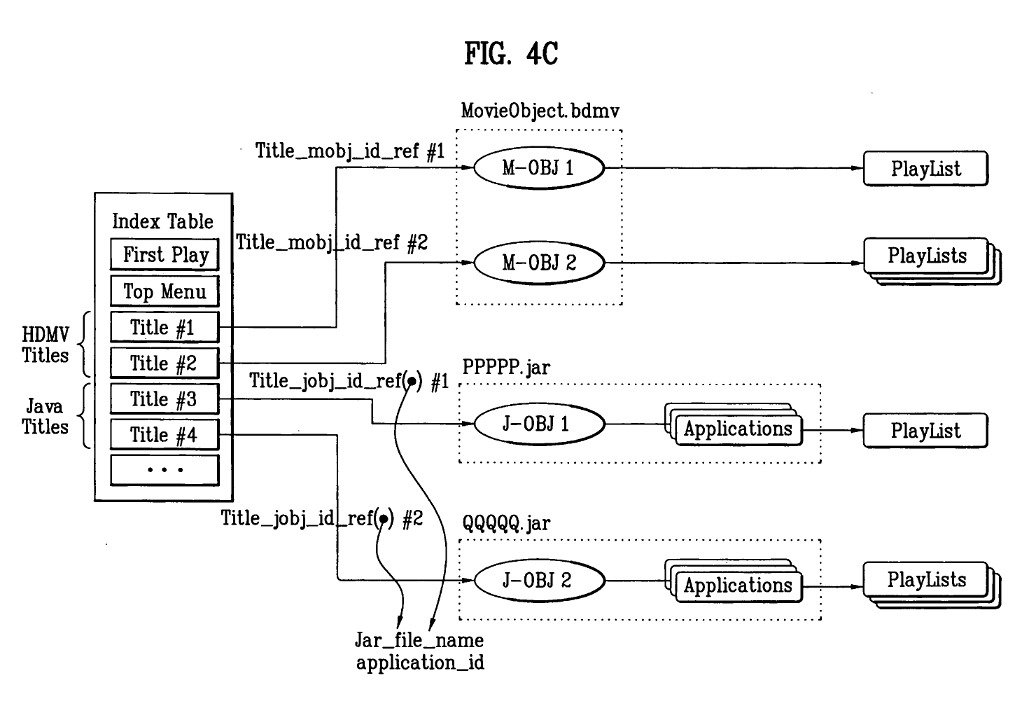

FIGS. 4a□4b are structural diagrams illustrating individual file structures recorded in a disc according to the present invention. FIG. 4c is a diagram illustrating a reproduction relationship using the file structures shown in FIGS. 4a□4b according to the present invention.

The file structure shown in FIG. 4a is equal to that of FIG. 2(a), such that configuration of object files managing the dynamic scenario will be described.

A first object (M-OBJ) for reproducing the HDMV title and a second object (J-OBJ) for reproducing the Java title are configured independently of each other. A plurality of first objects “M-OBJs” are included in a single movie object file (MovieObject.bdmv). A plurality of second objects “J-OBJs” are included in a corresponding Java program file (*.jar). For example, data “J-OBJ 1” is included in the file “PPPPP.jar”, and data “J-OBJ 2” is included in the file “QQQQQ.jar”.

Compared with the file structure shown in FIG. 4a, FIG. 4b shows a plurality of J-OBJs, which may be contained in individual Java program files (*.jar). For example, a plurality of objects (e.g., J-OBJ, J-OBJ 2, . . . ) are configured in the file “PPPPP.jar”, such that a disc capable of using various presentation scenarios can be manufactured. But, in this case, a start object must be determined in the file “PPPPP.jar”. For example, the first object “J-OBJ 1” may be used as a start object for executing the file “PPPPP.jar”. The above-mentioned content may also be applied to another file “QQQQQ.jar”.

FIG. 4c shows a reproduction relationship for reproducing a specific title according to the file structure shown in FIG. 4a. It is assumed that the titles #1 and #2 are HDMV titles and the titles #3 and #4 are Java titles in FIG. 4c.

If the disc having the above-mentioned file structure is seated in the optical recording/reproducing device 10, and the title #1 or #2 acting as the HDMV title is reproduced by a user's title reproduction selection command or a presentation scenario recorded in the disc, the object “M-OBJ 1” linked to the title #1 and the other object “M-OBJ 2” linked to the title #2 must firstly be executed. In order to execute the objects “M-OBJ 1” and “M-OBJ 2”, specific information “Title_mobj_id_ref” capable of loading the object linked to a corresponding title must be recorded in a syntax of the corresponding title. In association with the above-mentioned operation, the objects “M-OBJ 1” and “M-OBJ 2” are included in a single “MovieObject.bdmv” file as previously stated above.

If the disc having the above-mentioned file structure is seated in the optical recording/reproducing device 10, and the title #3 or #4 indicative of the Java title is reproduced by a user's title reproduction selection command or a presentation scenario recorded in the disc, the object “J-OBJ 1” linked to the title #3 and the other object “J-OBJ 2” linked to the title #4 must firstly be executed. In order to execute the objects “J-OBJ 1” and “J-OBJ 2”, specific information “Title_jobj_id_ref( )” capable of loading the object linked to a corresponding title must be recorded in a syntax of the corresponding title. In association with the above-mentioned operation, according to the file structures shown in FIG. 4a, the object “J-OBJ 1” is included in a single “PPPPP.jar” file as a corresponding Java program file, and the object “J-OBJ 2” is included in a single “QQQQQ.jar” file as a corresponding Java program file. Therefore, the “Title_jobj_id_ref( )” information must include first information (e.g., “Jar_file_name”) for designating a Java program file including a corresponding object “J-OBJ”. If the Java program file is composed of a plurality of applications, the “Title_jobj_id_ref( )” information may further include information designating specific applications therein.

Therefore, a command for finally reproducing the playlist file is executed by the “M-OBJ” object in the case of the HDMV title, and is executed by specific applications designated by the “J-OBJ” object in the case of the Java title.

In association with the above-mentioned description, FIGS. 4a□4c have no problem on the condition that the optical recording/reproducing device 10 can reproduce all titles. However, the optical recording/reproducing device 10 (also called “HDMV only Player”) capable of reproducing only a specific title such as the HDMV title cannot execute the Java title and the Java program file (“*.jar”, such that a menu image including all titles or an index file “index.bdj” may cause unexpected confusion or error.

For the optical recording/reproducing device capable of reproducing only the HDMV title, a menu image for the HDMV title must be pre-designed in a disc manufacturing process. If a presentation scenario is connected to titles having different attributes on the condition that the menu image is composed of only a specific title, the presentation scenario cannot be normally executed according to intention of a manufacturer of the disc, such that an additional presentation scenario is required to satisfy the intention of the disc manufacturer. A detailed description thereof will hereinafter be described.

FIG. 5a shows menu information according to the present invention. In more detail, FIG. 5a is a diagram illustrating a relationship for constructing a menu image using an index file recorded in the disc

For example, the index file “index.bdj” contained in the optical disc sets a configuration of titles having different attributes recorded in the disc to a menu, such that the menu is applied to a user. This operation is implemented by a specific field “Top menu”. If the “Top menu” field is exected by a menu search command of the user, a specific playlist is executed by a command or program of a specific object “M-OBJ” or “J-OBJ” contained in the “Top menu” field, and a specific stream file (e.g., xxxxx.m2ts) is reproduced by the above-mentioned playlist. In association with the above-mentioned description, a stream capable of performing a user interactivity function as shown in the menu image is referred to as an interactive graphic stream.

Therefore, if the stream file “xxxxx.m2ts” mainly composed of the interactive graphic stream is reproduced, a specific menu image contained in the display 30 is reproduced. In other words, as can be seen from FIG. 5a, it can be recognized that the menu image includes two HDMV titles (i.e., titles #1 and #2) and two Java titles (i.e., titles #3 and #4).

If the user selects a specific title by referring to the above-mentioned menu image, a corresponding title is reproduced via the object files and the playlist files as shown in FIG. 4c.

If the optical recording/reproducing device 10 can reproduce a specific title (e.g., the HDMV title), it is obvious to those skilled in the art that a reproduction command of the Java title cannot be executed using the optical recording/reproducing device 10. A menu image must be pre-constructed to prevent a user from selecting the Java titles (i.e., titles #3 and #4). A variety of methods for constructing only a reproduction title as a menu image will hereinafter be described with reference to FIGS. 5b□5d.

FIGS. 5b□5d show methods for constructing only a reproduction title as a menu image according to the present invention. Particularly, FIGS. 5b□5d show preferred embodiments for providing menu information to construct a plurality of menu images distinguished from each other in a recording medium.

In other words, FIGS. 5b□5d show method for including a plurality of Interactive Composition Segments (ICSs) contained in the interactive graphic stream, such that a plurality of menu images according to attributes can be provided. FIG. 5c shows a plurality of pages contained in the ICS to construct a plurality of menu images. FIG. 5d shows a plurality of button information units in the page to construct a plurality of menu images.

In association with the above-mentioned description, when a disc manufacturer records menu information in a corresponding disc, a plurality of menu information units are configured according to player type information (Player_type) for reproducing the corresponding disc. For example, menu information (also called “first menu information”) for use in a player capable of reproducing the HDMV title sets player type information to “Player_type=HDMV only”, and configures menu information associated with a corresponding title. In more detail, provided that the titles #1 and #2 are HDMV titles, only the titles #1 and #2 are included in the menu image. For example, menu information (also called “second menu information”) for use in a player capable of reproducing the HDMV titles and the Java titles sets player type information to “Player_type=Full mode”, and configures menu information associated with a corresponding title. In other words, all titles #1, #2, #3, and #4 including the Java titles are included in the menu image.

On the contrary, if the disc manufactured by the above-mentioned method is seated in a specific optical recording/reproducing device 10, the optical recording/reproducing device 10 reads menu information suitable for its own player type, and configures a menu image using the read menu information, such that it can provide a user with only a reproduction title configured in the form of a menu image.

FIG. 5b shows a plurality of ICSs according to player types. In more detail, for the optical recording/reproducing device 10 (i.e., HDMV only Player) capable of reproducing only the HDMV titles in the disc, the ICS composed of only two titles #1 and #2 is configured as first menu information. Also, for the optical recording/reproducing device 10 (i.e., Full mode Player) capable of reproducing not only the Java title but also all titles, the ICS composed of all titles #1, #2, #3, and #4 is configured as second menu information.

FIG. 5c shows a plurality of ICSs according to player types. In more detail, for the optical recording/reproducing device 10 (i.e., the HDMV only Player) capable of reproducing only the HDMV titles in the disc, a page composed of only two titles #1 and #2 is configured as first menu information. Also, for the optical recording/reproducing device 10 (i.e., Full mode Player) capable of reproducing not only the Java title but also all titles, a page composed of all titles #1, #2, #3, and #4 is configured as second menu information.

FIG. 5c shows a plurality of button information units contained in a specific page according to player types. In more detail, for the optical recording/reproducing device 10 (i.e., HDMV only Player) capable of reproducing only the HDMV titles in the disc, button information composed of only two titles #1 and #2 is configured as first menu information. Also, for the optical recording/reproducing device 10 (i.e., Full mode Player) capable of reproducing not only the Java title but also all titles, the button information composed of all titles #1, #2, #3, and #4 is configured as second menu information.

Although a specific title is selected and reproduced, scenario conversion from the selected title to another title may occur when the specific title is reproduced according to a presentation scenario. If the optical recording/reproducing device 10 can reproduce a specific title such as an HDMV title, scenario conversion from the HDMV title to the Java title may be abnormally performed.

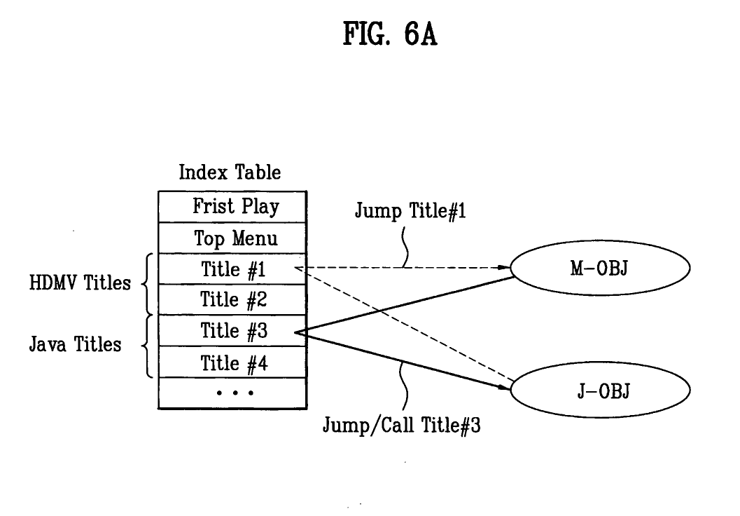

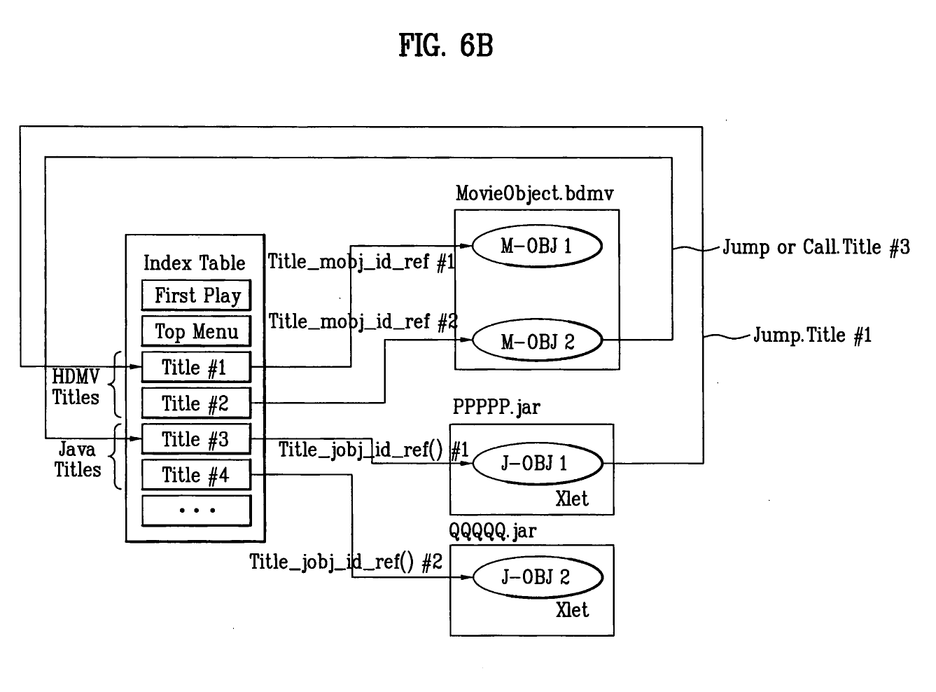

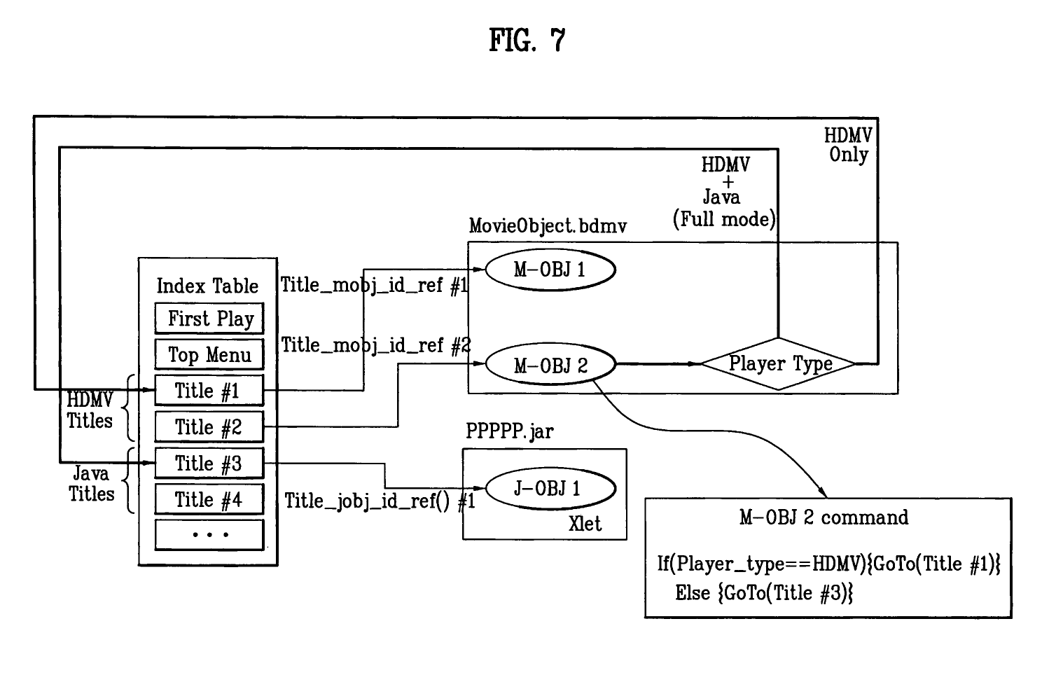

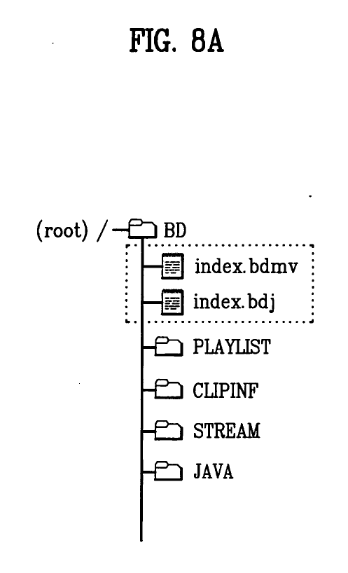

Therefore, there is a need for a manufactured disc to continuously reproduce a presentation scenario in consideration of the above-mentioned problem. A variety of methods for constructing the presentation scenario will hereinafter be described with reference to FIGS. 6a□9b.

FIG. 6a is a diagram illustrating a transition relationship between titles having different attributes according to the present invention. FIG. 6b is an exemplary presentation scenario using the transition relationship shown in FIG. 6a.

In association with the above-mentioned description, the transition relationship between the HDMV title and the Java title will hereinafter be described with reference to FIG. 6a.

Firstly, direct transition between objects having different attributes is not allowed. In more detail, direct transition is not allowed between objects “M-OBJ” and “J-OBJ” having different attributes. In this case, only transition performed by title conversion is allowed.

Secondly, during the title conversion, title conversion from the HDMV title to the Java title is performed by “Jump” and “Call/Resume” commands. The “Jump” command terminates a current title during a title conversion process, and is switched to another title. The “Call” command suspends a current title during a title conversion process, and is switched to another title. The “Resume” command performs the return to the suspended title. In other words, the “Call” and “Resume” commands act as a pair of commands.

For example, if the title #1 (i.e., the HDMV title) is converted into the title #3 (i.e., the Java title) as denoted by solid lines in FIG. 6a, conversion operations based on the “Jump” and “Call” commands are all allowed.

Thirdly, during the title conversion, title conversion from the Java title to the HDMV title is performed by only the “Jump” command. For example, if the title #3 (i.e., the Java title) is converted into the title #1 (i.e., the HDMV title) as denoted by dotted lines in FIG. 6a, only the “Jump” command is allowed.

Since transition between titles having different attributes is allowed as stated above, a user can conveniently reproduce a variety of titles when using a specific disc. The reason why the title conversion from the Java title to the HDMV title is not allowed by the “Call” command is that a Java system does not include a register for suspending a current reproduction state. Therefore, if the Java system includes a backup register, the title conversion from the Java title to the HDMV title may be performed by the “Call” command.

FIG. 6b shows an example of a presentation scenario using a transition relationship between the HDMV title and the Java title having different attributes. In FIG. 6b, the titles #1 and #2 are indicative of HDMV titles, and the titles #3 and #4 are indicative of Java titles.

In more detail, as can be seen from FIG. 6b, when reproducing the title #2 (i.e., the HDMV title), a presentation scenario is changed from the title #2 to the title #3 (i.e., the Java title) upon receiving the “Jump/Call” command or program. In this way, when reproducing the title #3 (i.e., the Java title), a presentation scenario is changed from the title #3 to the title #1 (i.e., the HDMV title) upon receiving the “Jump” command or program.

For example, if the above-mentioned title conversion is frequently performed, this means that various characters and environments are required in the same manner as in a game disc. Particularly, if a specific condition is established by a program while a user of the game disc does not recognize the title conversion, the title conversion may be automatically performed.

Therefore, provided that the optical recording/reproducing device 10 can reproduce only the HDMV title, scenario conversion caused by transition from the HDMV title to the Java title is not performed, such that unexpected errors occur at the title transition time point and disc data reproduction becomes meaningless.

FIG. 7 is a diagram illustrating a method for constructing the presentation scenario in accordance with a preferred embodiment of the present invention. Particularly, FIG. 7 shows a method for constructing a command contained in a movie object “M-OBJ” in consideration of a player type of the optical recording/reproducing device 10.

For example, if title transition is required for a specific reason when performing operations of the title #2 (i.e., the HDMV title using the “M-OBJ 2” object, category information of the transitioned title is changed according to player types.

In other words, if the optical recording/reproducing device 10 for reproducing data of a corresponding disc is indicative of a player type (Player_type ==Full mode) capable of reproducing both the HDMV title and the Java title, a current title is changed to the title #3 indicative of the Java title according to intension of a disc manufacturer. Otherwise, if the optical recording/reproducing device 10 for reproducing data of a corresponding disc is indicative of a player type (Player_type==HDMV) capable of reproducing only the HDMV title, a current title is changed to the title #1 indicative of the HDMV title.

Although the optical recording/reproducing device 10 can reproduce only the HDMV title (i.e., the optical recording/reproducing device 10 acts as an HDMV only player), the HDMV title instead of the Java title is reproduced according to a command contained in the movie object “M-OBJ”, such that data of the disc can be continuously reproduced.

As stated above, in order to construct a command capable of providing different titles executed in the movie object “M-OBJ”, a standardized format associated with a command program is required for a conditional branching operation depending upon a specific condition.

In association with the above-mentioned description, provided that there is an optical recording/reproducing device 10 capable of reproducing only the Java title, the Java object “J-OBJ” shown in FIG. 7 must be programmed to perform transition to the same Java title when changing a presentation scenario. However, if it is assumed that the optical recording/reproducing device 10 can reproduce the Java title, it is also assumed that the optical recording/reproducing device 10 can reproduce the HDMV title (i.e., Full mode). In this case, the Java object (J-OBJ) is programmed to perform title transition according to intention of a disc manufacturer. In other words, the Java object (J-OBJ) does not require the conditional branching operation as in the above-mentioned movie object “M-OBJ”.

FIGS. 8a□9b are diagrams illustrating methods for including an additional index file (index.bdmv) for the optical recording/reproducing device 10 capable of reproducing only the HDMV title, and constructing menu information and a presentation scenario using the index file (index.bdmv).

FIG. 8a is a structural diagram illustrating a plurality of index files contained in a file structure. As described above, the optical disc including both the HDMV title and the Java title requires an index file “index.bdj” including the HDMV and JAVA titles. However, the optical recording/reproducing device capable of reproducing only the HDMV title does not perform operations associated with the Java title and operations associated with the Java program file (*.jar). Therefore, the index file “index.bdj” including all titles may cause unexpected confusion or error. Therefore, for the optical recording/reproducing device capable of reproducing only the HDMV title, an index file “index.bdmv” for use in the HDMV title is additionally required in a disc manufacturing process.

FIG. 8b shows a method for constructing only a reproduction title in the form of a menu image according to the file structure of FIG. 8a. Particularly, FIG. 8b shows a plurality of index files classified in a recording medium, and a preferred embodiment for providing menu information capable of constructing a menu image.

In other words, an index file “index.bdmv” for the HDMV title and an index file “index.bdj” for the full mode are included in the optical disc. Individual index files “index.bdmv” and “index.bdj” store different “Top Menu” information.

Therefore, the optical recording/reproducing device 10 capable of reproducing only the HDMV title reproduces a specific movie object “M-OBJ” and a playlist (PlayList) file, which are linked to the “Top Menu” field, by referring to the above-mentioned “index.bdmv” file. In this case, the titles #3 and #4 indicative of Java titles are not provided to a screen of the display 30, as denoted by “No display”. Although the titles #3 and #4 are provided to the screen of the display 30, they are not selected by a user as denoted by “No activate”.

The optical recording/reproducing device 10 capable of reproducing not only the Java title but also all titles reproduces a specific object (i.e., J-OBJ or M-OBJ) and a specific playlist file, which are linked to the “Top Menu” field, by referring to the above-mentioned “index.bdj” file. In this case, all titles #1, #2, #3, and #4 recorded in the disc is provided to the screen of the display 30.

FIG. 8c shows a method for constructing only a reproduction title in the form of a menu image according to the present invention. Particularly, FIG. 8c shows a preferred embodiment for providing a recording medium with specific information capable of identifying individual titles, and providing menu information capable of constructing a menu image.

For example, if specific button information is contained in an interactive graphic stream capable of constructing a menu image in the optical recording/reproducing device, “Target_title” information is recorded as attribute information of the corresponding button information. For example, it is determined whether the corresponding button information is a button indicative of the HDMV title or a button indicative of the Java title, such that the optical recording/reproducing device 10 can properly cope with the determined result.

In association with the above-mentioned description, when the optical recording/reproducing device 10 capable of reproducing only the HDMV title constructs a menu image using the above-mentioned button information, it displays the button corresponding to the HDMV title on the screen by referring to the “Target_title” information. Due to the “Target_title” information, the button corresponding to the Java title is not provided to the screen of the display 30 as denoted by “No display”. Although the button corresponding to the Java title is provided to the screen of the display 30, they are not selected by the user as denoted by “No activate”.

In association with the above-mentioned description, the optical recording/reproducing device 10 capable of reproducing not only the Java title but also all titles provides the screen of the display 30 with buttons corresponding to all titles, irrespective of the “Target_title” information contained in the button information.

In association with the above-mentioned description, although individual index files “index.bdmv” and “index.bdj” are configured as shown in FIGS. 8b□8c to construct different “Top Menu” fields, it should be noted that the above-mentioned configurations of FIGS. 8b□8c aim to prevent the occurrence of an unexpected error in the menu image, and cannot prevent the occurrence of a presentation scenario error.

Therefore, an additional presentation scenario for the optical recording/reproducing device 10 capable of reproducing only the HDMV title must be configured. A detailed description of the additional presentation scenario will hereinafter be described with reference to FIGS. 8d□9b.

FIG. 8d shows a method for constructing only a presentation scenario for use in the optical recording/reproducing device 10 capable of reproducing only the HDMV title. Particularly, FIG. 8d shows a preferred embodiment for maintaining scenario continuity using a conventional object “M-OBJ” without constructing an additional object “M-OBJ”.

For the convenience of description, the optical recording/reproducing device 10 capable of reproducing only the HDMV title uses only the “index.bdmv” file from among index files, such that a presentation scenario constructed by the “index.bdmv” field will hereinafter be described.

In other words, the optical recording/reproducing device 10 capable of reproducing only the HDMV title can reproduce only the titles #1 and #2 indicative of the HDMV titles, and cannot reproduce the titles #3 and #4 indicative of the Java titles. This means that the optical recording/reproducing device 10 cannot reproduce the Java program and the Java object “J-OBJ”. Therefore, if the title #2 indicative of the HDMV title is transitioned to the title #3 for a specific reason when the title #2 is reproduced by the “M-OBJ 2” object, the object linked to the title #3 is set to a specific movie object (e.g., “M-OBJ 1”) instead of a conventional Java object “J-OBJ 1”, and the title #1 is then reproduced. For reference, in the case of the “Full mode”, the object linked to the title #3 is set to the Java object “J-OBJ 1”, and is transitioned to the title #1 according to a presentation scenario, as denoted by dotted lines in FIG. 8d. Therefore, although the optical recording/reproducing device 10 can reproduce only the HDMV title, a dynamic scenario based on only the movie object “M-OBJ” is configured by the index file “index.bdmv”. As a result, the HDMV title instead of the Java title can be continuously reproduced, and the number of errors can be reduced when data of the disc is reproduced.

FIG. 8e shows a method for constructing only a presentation scenario for use in the optical recording/reproducing device 10 capable of reproducing only the HDMV title according to the file structure of FIG. 8a. Particularly, FIG. 8e shows a preferred embodiment for constructing an additional object “M-OBJ” to maintain scenario continuity.

For the convenience of description, the optical recording/reproducing device 10 capable of reproducing only the HDMV title uses only the “index.bdmv” file from among index files, such that a presentation scenario constructed by the “index.bdmv” field will hereinafter be described.

For example, if the title #2 indicative of the HDMV title is transitioned to the title #3 due to a specific cause, a predetermined command sets the object linked to the title #3 to an additional movie object “M-OBJ 3” instead of a conventional Java object “J-OBJ 1”, and controls the “M-OBJ 3” object to jump to a specific HDMV title (e.g., Title #1), such that the command can enable the title #1 to be reproduced again. Therefore, although the optical recording/reproducing device 10 can reproduce only the HDMV title, a dynamic scenario based on only the movie object “M-OBJ” is configured by the index file “index.bdmv”. As a result, the HDMV title instead of the Java title can be continuously reproduced, and the number of errors can be reduced when data of the disc is reproduced.

In association with the above-mentioned description, the preferred embodiment shown in FIG. 8e relates to a method for constructing an additional movie object (e.g., “M-OBJ 3”). The preferred embodiment shown in FIG. 8d is characterized in that a presentation scenario based on a conventional movie object (e.g., “M-OBJ 1”) is constructed without constructing a new movie object.

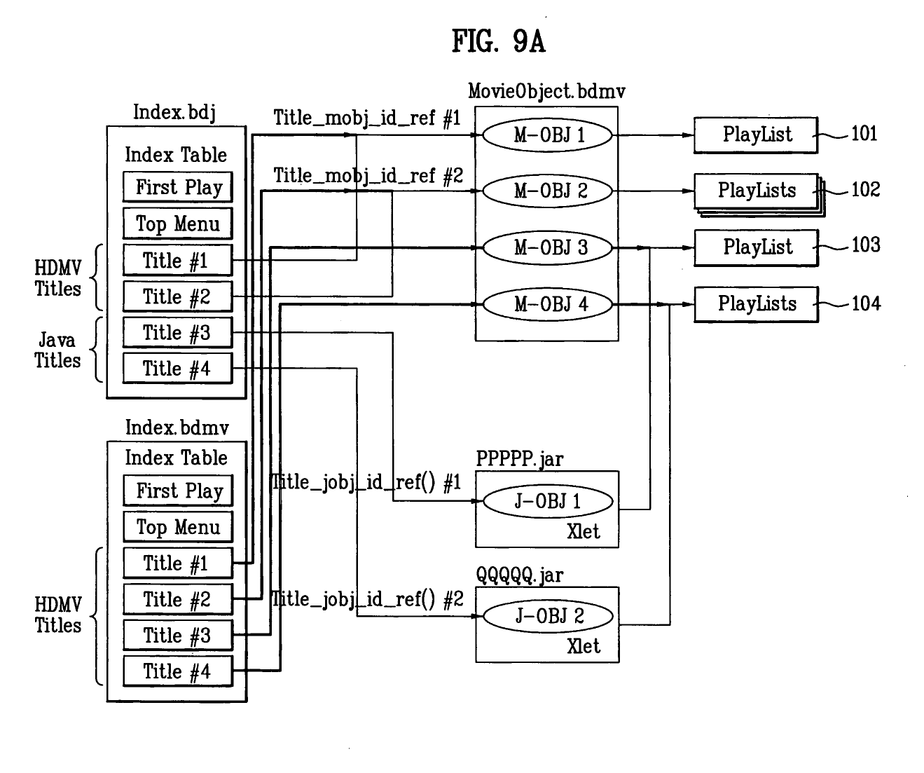

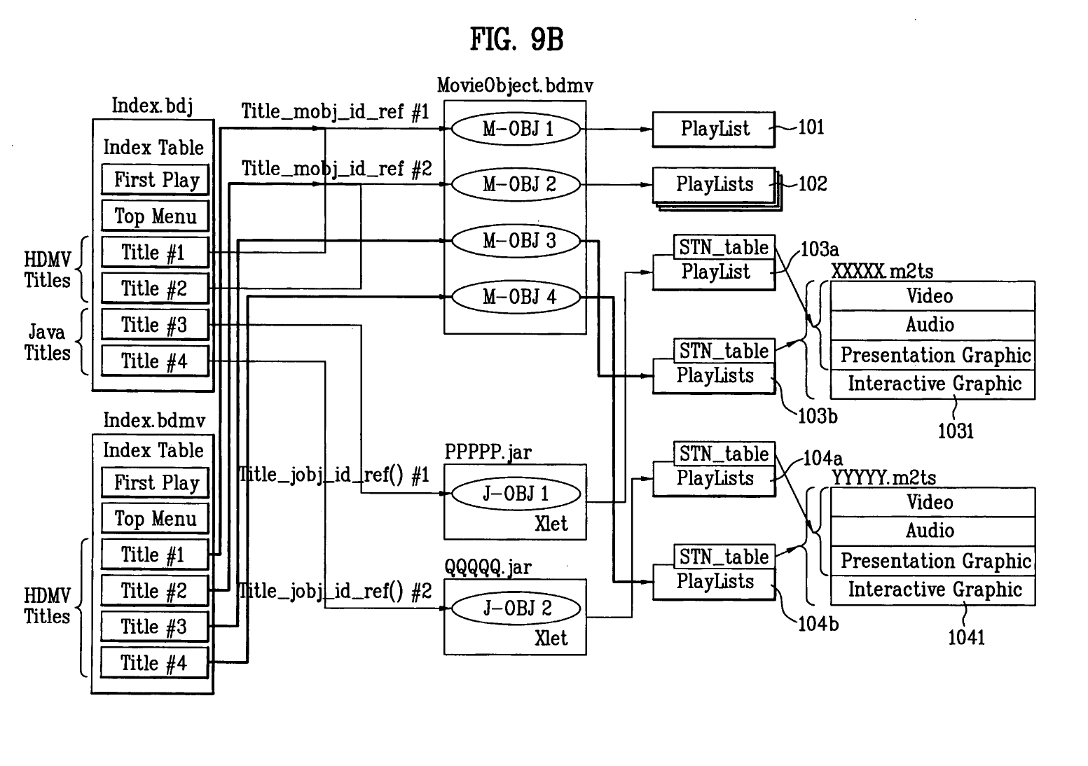

FIGS. 9a□9b are diagrams illustrating a method for constructing a presentation scenario for use in the optical recording/reproducing device 10 capable of reproducing only the HDMV title. Particularly, FIGS. 9a□9b show a preferred embodiment for performing transition from the Java title to the HDMV title to maintain scenario continuity.

Referring to FIG. 9a, the “index.bdj”file from among a plurality of index files is indicative of an index file applied to the “Full mode” optical recording/reproducing device capable of reproducing even the Java title, and the “index.bdmv”file is indicative of an index file applied to the “HDMV only” optical recording/reproducing device capable of reproducing only the HDMV title. In association with the above-mentioned description, according to the configuration shown in FIG. 9a, all titles contained in the “index.bdmv” field are composed of HDMV titles, and titles #3 and #4 indicative of Java titles in the “index.bdj” file are transitioned to the HDMV titles in such a way that a presentation scenario is configured.

The title #3 contained in the “index.bdmv” file is linked to an additional movie object “M-OBJ 3”, a playlist reproduced by the “M-OBJ 3” object is equal to a playlist equal to the playlist 103 reproduced by the Java object “J-OBJ 1” linked to the conventional Java title #3. In this way, the title #4 contained in the “index.bdmv” field is linked to an additional movie object “M-OBJ 4”, a playlist 104 reproduced by the “M-OBJ 4” object is equal to a playlist 104 reproduced by the Java object “J-OBJ 2” linked to the conventional Java title #4.

Since the index file “index.bdmv” for use in only the HDMV title and the movie objects “M-OBJ 1”□“M-OBJ 4” is configured, the optical recording/reproducing device 10 capable of reproducing only the HDMV title can always reproduce only the HDMV title, and can maintain a presentation scenario without any change.

FIG. 9b shows a method for employing a playlist when the index file “index.bdmv” and the movie objects “M-OBJ 1” □ “M-OBJ 4”. Particularly, FIG. 9n shows a detailed method for employing the playlist.

Referring to FIG. 9a, specific playlists 103 and 104 are equally used by the index files “index.bdmv” and “index.bdj”. Generally, a video stream, an audio stream, a presentation graphic stream, and an interactive graphic stream are multiplexed in each of stream files “xxxxx.m2ts” and “yyyyy.m2ts”. The video stream, the audio stream, the presentation graphic stream, and the interactive graphic stream are used when the HDMV title is reproduced. However, streams for the Java title do not require the interactive graphic stream because interactive information is pre-programmed in the Java program. Therefore, when reproducing the Java title the playlist file 103a must be constructed to control individual interactive graphic streams contained in the stream files “xxxxx.m2ts” and “yyyyy.m2ts” not to be used.

In other words, “STN_table” information contained in the playlist file is used as information for designating a stream capable of being reproduced as a playlist. When constructing the “STN_table” information in the above-mentioned playlist file, the playlists 103a and 104a for the Java title must be designed not to designate an interactive graphic stream 1031 contained in the stream file “xxxxx.m2ts” and an interactive graphic stream 1041 contained in the stream file “yyyyy.m2ts”. When constructing the “STN_table” information, the playlists 103b and 103b for the HDMV title must be designed to designate the interactive graphic stream 1031 contained in the stream file “xxxxx.m2ts” and an interactive graphic stream 1041 contained in the stream file “yyyyy.m2ts”.

If a disc in which the playlist files are constructed without any difference in the “STN_table” information is seated in the optical recording/reproducing device 10, the optical recording/reproducing device 10 may determine whether to use the interactive graphic streams 1031 and 1041 according to category information of reproduced titles, and may reproduce desired data.

It is obvious to those skilled in the art that transition among titles in the above-mentioned file structure can be performed without any problem although it is not shown in FIGS. 9a□9b. In other words, the optical recording/reproducing device 10 capable of reproducing only the HDMV title determines a presentation scenario by referring to the index file “index.bdmv” for only the HDMV title and movie objects “M-OBJ 1” □ “M-OBJ 4”. In this case, all titles contained in the index file “index.bdmv” are HDMV titles, such that there is no problem in performing transition among titles according to the presentation scenario.

FIGS. 10a□10b are block diagrams illustrating an optical recording/reproducing device according to the present invention. Particularly, FIG. 10a is a block diagram illustrating the optical recording/reproducing device 10 according to the present invention, and FIG. 10b is a block diagram illustrating a reproduction processor 17 or player model for reproducing data of a disc in which titles having different attributes are recorded according to the present invention.

The optical recording/reproducing device 10 according to the present invention will hereinafter be described with reference to FIG. 10a.

Referring to FIG. 10a, the optical recording/reproducing device 10 includes a pickup unit 11, a servo unit 14, a signal processor 13, a memory 15, and a microprocessor 16. The pickup unit 11 reads data recorded in a title record area of an optical disc, and reads management information including file information recorded in a management area. The servo unit 14 controls operations of the pickup unit 11. The signal processor 13 receives a reproduction signal from the pickup unit 11, restores the received reproduction signal to a desired signal value, or modulates a signal to be recorded into another signal recorded in the optical disc, such that it transmits the recovered or modulated result. The memory 15 stores information needed for reproducing data of the disc. The microprocessor 16 controls overall operations of the above-mentioned components contained in the optical recording/reproducing device 10. In association with the above-mentioned operations, the combination of the above-mentioned components 11, 14, 13, 15, and 16 is also called a recording/reproducing unit 20, and the recording/reproducing unit 20 can be manufactured in the form of a single product.

A controller 12 controls all the constituent components shown in FIG. 6a. Specifically, the controller 12 receives a reproduction command of a specific title by interfacing with a user according to the present invention.

The reproduction processor 17 finally decodes output data upon receiving a control signal from the controller 12, and transmits the decoded result to the user. The reproduction processor 17 includes a decoder 17a for decoding AV signals; and a player model 17b for analyzing a command or program contained in the object and a user command received from the controller 12 in association with reproduction of the above-mentioned specific title, and determining a reproduction direction on the basis of the analyzed result.

However, it should be noted that the player model 17b may include the decoder 17a in some preferred embodiments, and the reproduction processor 17 may correspond to the player model shown in FIG. 6b.

An encoder 18 converts an input signal into a specific format signal (e.g., an MPEG2 transport stream) upon receiving a control signal from the controller 12, and transmits the converted result to the signal processor 13, such that it can record a desired signal in the optical disc.

FIG. 10b is a detailed block diagram of the player model according to the present invention. The player model includes a module manager 171, a movie module 172, a BDJ module 173, a playback control engine 174, and a presentation engine 175. FIG. 10b shows a full-mode player model capable of reproducing the Java title. Provided that the player model is indicative of an “HDMV only Player” model capable of reproducing only the HDMV title, it is obvious to those skilled in the art that the BDJ module 173 for reproducing the Java title is omitted, and a detailed description thereof will hereinafter be given.

The movie module 172 acting as an additional reproduction process module capable of reproducing the HDMV title and the BDJ module 173 acting as an additional reproduction process module capable of reproducing the Java title are constructed independently of each other. The movie module 172 receives a command or program contained in the above-mentioned object “M-OBJ”, and the BDJ module 173 receives a command or program contained in the above-mentioned object “J-OBJ”, such that the movie module 172 and the BDJ module 173 process the received command or program.

The movie module 172 includes a command processor 172a, and the BDJ module 173 includes an application manager 173a and a JAVA VM 173b, such that the movie module 172 and the BDJ module 173 are capable of receiving/processing the above-mentioned command.

The player model shown in FIG. 10b includes the module manager 171, the playback control engine 174, and the presentation engine 175. The module manager 171 transmits a user command to the movie module 172 and the BDJ module 173, and controlling operations of the BDJ module 173. The playback control engine 174 analyzes playlist file content (associated with a static scenario) recorded in a disc upon receiving a reproduction command from the movie module 172 and the BDJ module 173, and performs a reproduction function on the basis of the analyzed result.

The presentation engine 175 displays a specific stream reproduced/managed by the playback control engine 174.

The playback control engine 174 includes a playback control function 174a for managing all the reproduction operations; a player status register (PSR) for indicating a reproduction environment or reproduction status of the player; and a player register 174b for storing general purpose register (GPR) information. The playback control function 174b may also be indicative of the playback control engine 174 as necessary.

The module manager 171, the movie module 172, the BDJ module 173, and the playback control engine 174 contained in the player model shown in FIG. 10b can be processed by software. It is preferable that the above-mentioned components 171, 172, 173, and the 174 be processed by software instead of hardware. The presentation engine 175, the decoder 17a, and the graphic planes 17c and 17d are generally hardware based. Constituent components (e.g., 171, 172, 173, and 174) processed by software may be integrated in one unit, such that the integrated unit may be installed into the controller 12. Therefore, it should be noted that the above-mentioned components of the present invention be understood on the basis of their meanings, and are not limited to their implementation methods such as hardware or software implementation.

In association with the above-mentioned description, the characteristics of the player model are as follows.

Firstly, as stated above, the movie module 172 for the HDMV title and the BDJ module 173 for the Java title are configured independently of each other, and the two modules 172 and 173 cannot be executed at the same time. In more detail, the Java title cannot be reproduced when the HDMV title is reproduced, and the HDMV title cannot be reproduced when the Java title is reproduced.

Secondly, the HDMV title and the Java title receive user commands based on different schemes, respectively. The HDMV title and the Java title use different methods for performing individual user commands. There is needed a predetermined unit capable of receiving the user command, and transmitting the received user command to either the movie module 172 or the BDJ module 173. In this case, the above-mentioned operations are performed by the user event manager 171a contained in the module manager 171. For example, if the received command is determined to be a user command entered by a User Operation (UO), the user event manager 171a transmits the user command to a UO controller 172b contained in the movie module 172. Otherwise, if the received command is determined to be a user command entered by a key event, the user event manager 171a transmits the received user command to the Java VM 173b contained in the BDJ module 173.

Thirdly, one of the modules 172 and 172 manages the above-mentioned playback control engine 174. In more detail, when reproducing the HDMV title, the movie module 172 acts as a master of the playback control engine 174. When reproducing the Java title, the BDJ module 173 acts as a master of the playback control engine 174.

Fourthly, the graphic plane is independently managed. For example, the operation of an HDMV plane 17c is mastered by the presentation engine 175, and the operation of a Java plane 17d is mastered by the Java VM 173b included in the BDJ module 173.

A method for reproducing data of the optical disc using the above-mentioned optical recording/reproducing device will hereinafter be described. If a disc in which a reproduction/management file structure shown in one of FIGS. 2□9b is recorded is loaded in the optical recording/reproducing device, the microprocessor 16 reads reproduction/management file information recorded in the loaded disc using the pickup unit 11, and stores the read reproduction/management file information in the memory 15. Upon receiving a user selection command for reproducing a specific title from the controller 12, the microprocessor 16 reads specific data according to a presentation scenario corresponding to the selected title, and transmits the read data to the player model shown in FIG. 10b. Thereafter, the player model shown in FIG. 10b recognizes a presentation scenario on the basis of various information of a corresponding title, for example, an attribute, a dynamic scenario acting as an object file, and a static scenario acting as a playlist file, drives one of the movie module 172 and the BDJ module 173 according to the presentation scenario, and finally reproduces a user-selected title.

As apparent from the above description, a recording medium, and a method and apparatus for reproducing data from the recording medium according to the present invention can record data having different attributes in a single recording medium, and can provide a user with the single recording medium. Also, the present invention can effectively reproduce/manage the recording medium, resulting in greater convenience of use.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A recording medium comprising:
an area in which a first title and a second title having different attributes are recorded; and
a management area for reproducing individual titles having different attributes,
wherein the management area records a first index file for a first player capable of reproducing only a specific title, and a second index file for a second player capable of reproducing all titles.

2. The recording medium according to claim 1, wherein the first title is an HDMV title, and the second title is a Java title.

3. The recording medium according to claim 2, wherein the first index file includes index information for the player capable of reproducing only the HDMV file.

4. The recording medium according to claim 3, wherein the Java title contained in the first index file is linked to a movie object (M-OBJ) when constructing the first index file.

5. The recording medium according to claim 2, wherein the first index file further includes menu information for use in the player capable of reproducing only the HDMV title.

6. The recording medium according to claim 3, wherein all titles contained in the first index file links are linked to a movie object (M-OBJ), and include a command for performing a specific playlist (PlayList).

7. The recording medium according to claim 6, wherein the Java title is transitioned to the HDMV title in the first index file, and the Java title is maintained in the second index file.

8. The recording medium according to claim 7, wherein a playlist (PlayList) performed by the Java title contained in the second index file is equal to a playlist performed by the HDMV title contained in the first index file (index.bdmv).

9. The recording medium according to claim 7, wherein a playlist (PlayList) performed by the java title contained in the second index file does not reproduce an interactive graphic stream, and a playlist performed by the HDMV title contained in the first index file (index.bdmv) includes the interactive graphic stream such that it is reproduced with the interactive graphic stream.

10. A recording medium comprising:
an area in which a first title and a second title having different attributes are recorded; and
an area in which at least one menu information for constructing different menu images according to reproduction or non-reproduction information of the first and second titles is recorded.

11. The recording medium according to claim 10, wherein the first title is an HDMV title, and the second title is a Java title.

12. The recording medium according to claim 11, wherein the menu information is classified into first menu information capable of displaying only the HDMV title, and second menu information capable of displaying both the HDMV title and the Java title.

13. The recording medium according to claim 12, wherein the first menu information and the second menu information are recorded in an interactive graphic stream file.

14. The recording medium according to claim 13, wherein the interactive graphic stream includes an interactive composition segment (ICS) for the first menu information and an ICS for the second menu information.

15. The recording medium according to claim 13, wherein the interactive graphic stream includes page information, and the page information is classified into first page information for the first menu information and second page information for the second menu information.

16. The recording medium according to claim 13, wherein the interactive graphic stream includes button information, and the button information is classified into first button information for the first menu information and second page information for the second menu information.

17. The recording medium according to claim 12, wherein the first menu information and the second menu information are recorded in a plurality of independent index files capable of being classified from each other.

18. The recording medium according to claim 10, wherein the menu information is indicative of information capable of identifying the first title and the second title.

19. A recording medium comprising:
an area in which a first title and a second title having different attributes are recorded; and
a management area for reproducing individual titles having different attributes,
wherein the management area records a presentation scenario for use in a player capable of reproducing only a specific title.

20. The recording medium according to claim 19, wherein the first title is an HDMV title, and the second title is a Java title.

21. The recording medium according to claim 19, wherein the management area further records a presentation scenario for use in a player capable of reproducing only the HDMV title.

22. The recording medium according to claim 21, wherein the presentation scenario for use in the player capable of reproducing only the HDMV title provides different commands according to player-type information contained in a movie object (M-OBJ).

23. The recording medium according to claim 19, wherein the management area further records menu information for use in the player capable of reproducing only the specific title.

24. A method for reproducing data of a recording medium in which a first title and a second title having different attributes are recorded and a plurality of index files for reproducing individual titles having different attributes are recorded, comprising the steps of:
(a) selecting one of the index files recorded in the recording medium according to player type information; and
(b) reproducing data of the recording medium using presentation scenario information recorded in the selected index file.

25. A method for reproducing data of a recording medium in which a first title and a second title having different attributes are recorded and menu information for reproducing the first and second titles having different attributes according to player type (player_type) information is recorded, comprising the steps of:
(a) selecting one of first menu information of the first title recorded in the recording medium and second menu information including the second title recorded in the recording medium according to the player type (player_type) information;
(b) displaying a menu image using the selected menu information; and
(c) reproducing a specific title contained in the displayed menu image according to a reproduction command of a user.

26. The method according to claim 25, further comprising the step of:
(d) displaying a Java title when a menu image is displayed by HDMV title menu information, and preventing the Java title from being selected by the user.

27. A method for reproducing data of a recording medium in which a first title and a second title having different attributes are recorded and a presentation scenario changed according to player type information is recorded, comprising the steps of:
(a) if the recording medium is loaded, reading a scenario capable of being reproduced from the recording medium; and
(b) reproducing data of the recording medium according to the read scenario.

28. An apparatus for reproducing data of a recording medium in which a first title and a second title having different attributes are recorded and different presentation scenarios according to player type information are recorded, the apparatus comprising:
a recording/reproducing unit for reading a presentation scenario capable of being reproduced, from among the presentation scenarios recorded in the recording medium; and
a player model for reproducing a specific title on the basis of the read presentation scenario.

29. An apparatus for reproducing data of a recording medium in which a first title and a second title having different attributes are recorded and menu information for reproducing the first and second titles having different attributes according to player type (player_type) information is recorded, the apparatus comprising:
a recording/reproducing unit for reading one of first menu information of the first title recorded in the recording medium and second menu information including the second title recorded in the recording medium according to the player type (player_type) information; and
a player model for displaying a menu image using the read menu information, and reproducing a specific title contained in the menu image according to a reproduction command of a user.
